(19) United States
(12) Patent Application Publication
(10) Pub. No.: US 2023/0214025 A1
(43) Pub. Date: Jul. 6, 2023

(54) GESTURE AREAS

(71) Applicant: Hewlett-Packard Development Company, L.P., Spring, TX (US)

(72) Inventors: Mark Allen Lessman, Fort Collins, CO (US); Robert Paul Martin, Fort Collins, CO (US)

(73) Assignee: Hewlett-Packard Development Company, L.P., Spring, TX (US)

(21) Appl. No.: 17/999,498

(22) PCT Filed: May 22, 2020
(86) PCT No.: PCT/US2020/034249

§ 371 Date: Nov. 21, 2022

(51) Int. Cl. G06F 3/01; G06V 20/20; G06V 40/20

(52) U.S. Cl. CPC G06F 3/017; G06V 20/20; G06V 40/28

(57) ABSTRACT

In some examples, a machine-readable medium can store instructions executable by a processing resource to designate a first field of view of a first sensor of a head-mounted display as an active area, designate a second field of view of a second sensor of the head-mounted display as a gesture area, detect, when present, a gesture in the gesture area and cause an effect of the gesture to occur responsive to detection of the gesture.

### BACKGROUND

Extended reality (KR) devices can be used to provide an extended reality to a user. An extended reality refers to a computing device generated scenario that simulates experience through senses and perception. For instance, XR devices can include a display to provide a “virtual, mixed, and/or augmented” reality experience to the user by providing video, images, and/or other visual stimuli to the user via the display. XR devices can be worn by a user. Examples of XR devices include virtual reality (VR) devices, mixed reality (MR) devices, and/or an augmented reality (AR) devices.

### BRIEF DESCRIPTION OF THE DRAWINGS

FIG. 1 is a side-view of an example of a head-mounted display (HMD) having a gesture area.

FIG. 2 is a top view of the example of a HMD of FIG. 1.

FIG. 3 is another top view of the example of a HMD of FIG. 1.

FIG. 4 is a side-view of an example of system including a HMD having a gesture area.

FIG. 5 is an example of a machine-readable medium storing instructions executable by a processing resource to provide a gesture area.

### DETAILED DESCRIPTION

As mentioned, extended reality (XR) devices can provide video, audio, images, and/or other stimuli to a user via a display. As used herein, an “XR device” refers to a device that provides a virtual, mixed, and/or augmented reality experience for a user.

An XR device can be a head-mounted display (HMD). As used herein, a “head-mounted display” refers to a device to hold an display near a user's face such that the user can interact with the display. For example, a user can wear the HMD to view the display of the XR device and/or experience audio stimuli provided by the XR device.

XR devices can cover a user's eyes and/or ears to immerse the user in the virtual, mixed, and/or augmented reality created by a XR device. For instance, an XR device can cover a user's eyes to provide visual stimuli to the user via a display, thereby substituting an “extended” reality (e.g., a “virtual reality”, a “mixed reality”, and/or an “augmented reality”) for actual reality.

For example, an XR device can overlay a transparent or semi-transparent display in front of a user's eyes such that reality is “augmented” with additional information such as graphical representations and/or supplemental data. An XR device can cover a user's ears and provide audible stimuli to the user via audio output devices to enhance the virtual reality experienced by the user. The immersive experience provided by the visual and/or audio stimuli of the XR device can allow the user to experience a virtual and/or augmented reality with realistic images, sounds, and/or other sensations.

An immersive XR experience can be enhanced by utilizing gestures. As used herein, a “gesture” refers to a predefined motion/articulation and/or orientation of an object such as a hand controller/hand of a user utilizing a XR device. An XR device can use sensors such as cameras, ultrasonic sensor, time-of-flight sensors, and/or other types of sensors for gesture detection. For example, an XR device can utilize a camera to detect an orientation and/or motion of a hand of a user, Gestures can be performed in the user's field of view (or virtual field of vison as in VR). For instance, gestures can be used to interact (zoom in/out, select, grab, etc.) with virtual objects in a field of view/virtual field of view of a user.

However, gesture detection can be a computationally intensive and/or consume computational bandwidth that could be used for other tasks such as pose/position/controller tracking. Moreover, gestures can be inadvertently performed in front of a user/in a user's field of view when performing other tasks and thereby cause an unintended effect responsive to detection of the inadvertent gesture.

Gesture areas, as detailed herein, can be designated as a field of view of a side-facing camera in a HMD to detect a gesture in a designated gesture area that, notably, is located to the “side” of a user wearing the HMD. As used herein, “designation of a gesture area” refers to designation of a field of view of a sensor for detection of a gesture. Thus, gesture areas as detailed herein can eliminate detection of any inadvertent gestures performed in a “front” active area in the user's field of view. Further, gesture areas as detailed herein can reduce computational overhead/latency by reducing a total number of sensors and resultant sensor data associated with gesture detection.

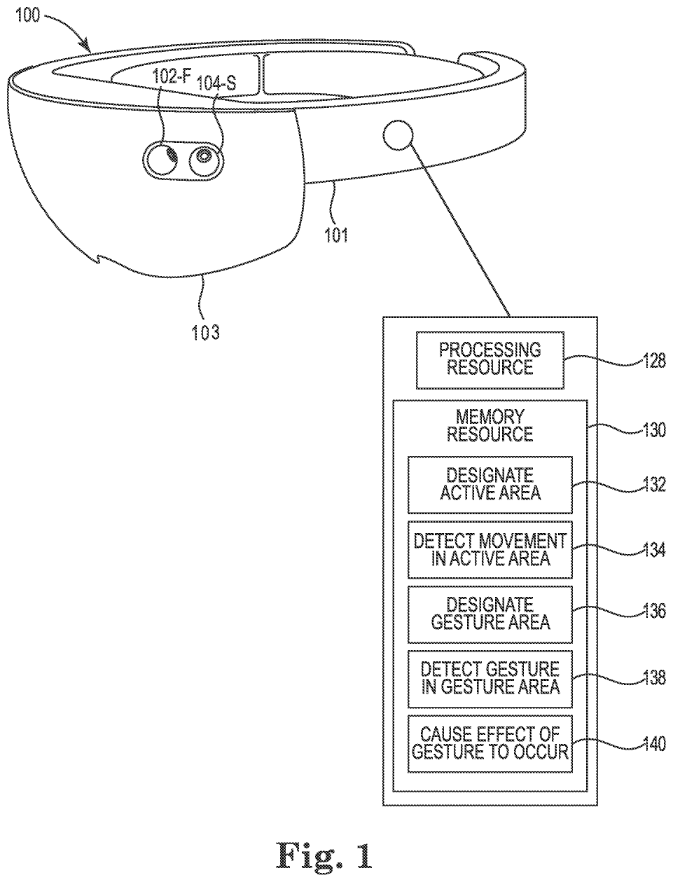

FIG. 1 is a side-view of an example of a HMD 100 having a gesture area. The HMD 100 be a mixed reality (MR) device and/or an augmented reality (AR) device, as illustrated in FIG. 1, with an enclosure/display that partially covers a field of view of user. As used herein, an AR device can include a display that can visually enhance or visually alter a real-world area for a user of the device. For example, the AR device can allow a user to view a real-world area while also viewing displayed images by the AR device. As used herein, a MR device refers to device including a display to provide a hybrid of an actual reality and virtual reality that can merge real and virtual worlds, for instance, to produce new environments and visualizations, where physical and digital objects can co-exist and interact in real time. However, in some example the HMD 100 can be a virtual reality (VR) device such as those with an enclosure that entirely covers a natural field of view of a user and/or covers the ears of a user wearing the HMD 100. As used herein, a VR device can include a display that can generate a virtual area or virtual experience for a user. For example, the VR device can generate a virtual world that is separate or distinct from the real-world location of the user. In any case, the HMD 100 can house various devices to provide an XR experience to a user. Such devices can include displays, speakers, haptic feedback devices, among other types of devices.

As illustrated in FIG. 1, the HMD 100 can include a head strap 101, a display 103, and a plurality of sensors such as a first sensor 102-F and a second sensor 104-S. As used herein, a “head strap” refers to a strip of material to fasten and/or hold an HMD on a user's head. A user can wear HMD 100 utilizing the head strap 101. Head strap 101 can be formed of an elastic material such as an elastomer and/or a rigid material such as plastic, among other examples of suitable materials. For example, head strap 101 can be a looped band which fastens to a user's head such that the head strap 101 secures the HMD 100 to a user's head, among other possibilities.

Although the HMD 100 is illustrated in FIGS. 1, 2, 3, and 4 as including a head strap, in some examples the HMD 100 does not include a head strap. For example, HMD 100 can be attached to a stand. The stand can hold the HMD 100 on, for instance, a desktop when the HMD 100 is not in use by a user. When the user of the HMD 100 is ready to utilize the HMD 100, the user can grab the stand and position the HMD 100 on the user's face for use using the stand.

The display 103 can cover some or all of a user's natural field of view when wearing the HMD 100. The display 103 can be liquid crystal display, light-emitting diode (OLED) display or other types of displays that permit display of content. The display 103 can be transparent (composed of glass, mirrors and/or prisms), semi-transparent, or opaque.

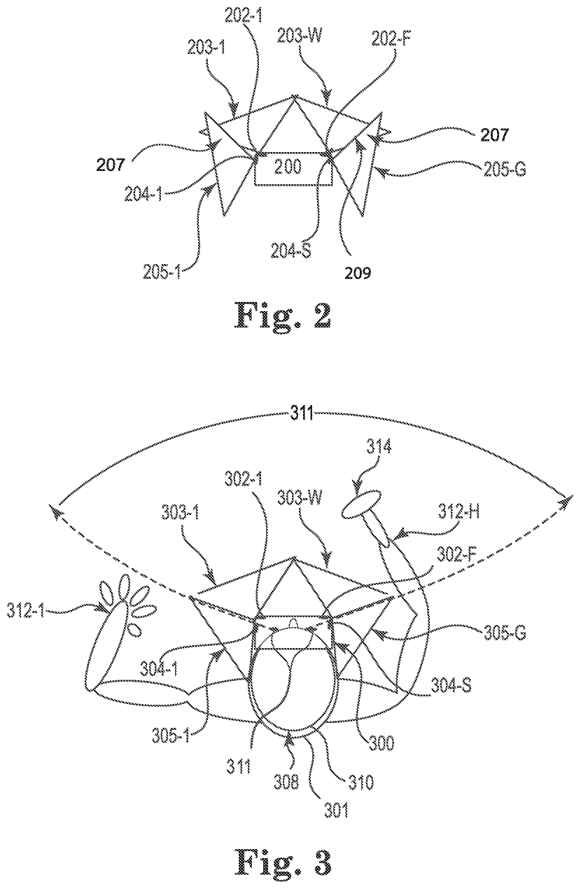

As mentioned, the HMD 100 can include a plurality of sensors. As used herein, a “sensor” refers to a device to detect events and/or changes in its environment and transmit the detected events and/or changes for processing and/or analysis. As illustrated in FIG. 1, the plurality of sensors such as the first sensor 102-F and the second sensor 104-S can be outward facing sensors. As used herein, “outward facing” refers to a sensor that has a field of view/detection area oriented away from a user when the user wears the HMD 100. For instance, the first sensor 102-F can have a first field of view (e.g., first field of view 203-W as described with respect to FIG. 2) that is outward facing and the second sensor 104-S can have a second field of view (e.g., second field of view 205-G as described with respect to FIG. 2) that is also outward facing.

In some examples, the plurality of sensors (e.g., cameras, ultrasonic sensor, time-of-flight sensors, and/or other types of sensors) can be included in the head strap 101, in a display 103, and/or included elsewhere in the HMD 100. For instance, as illustrated in FIG. 1 the first sensor 102-F and the second sensor 104-S can be included in the display 103. However, in some examples, the first sensor 102-F and the second sensor 104-S can be included in a different location on the HMD 100 such as being mounted to or included in the display 103, among other possibilities.

In some examples, the first sensor 102-F and the second sensor 104-S are cameras with respective frame rates. As used herein, a “frame rate” refers to a rate at which frames are taken and/or processed. In some instances, a frame rate of the first sensor 102-F can be higher than a frame rate of the second sensor 104-S. Having a higher frame rate on the first sensor 102-F can decrease latency with regard to detection of position, pose, and/or controller movements, and yet decrease overall computation bandwidth (e.g., as utilized by the processing resource 128 in the HMD 100) by virtue of having a lower frame rate associated with the second sensor 104-S which is utilized for gesture detection in the gesture area.

Although the following descriptions refer to an individual processing resource and an individual memory resource, the descriptions can also apply to a system with multiple processing resources and/or multiple memory resources. Put another way, the instructions executed by the processing resource 128 can be stored across multiple machine-readable storage mediums and/or executed across multiple processing resources, such as in a distributed or virtual computing environment.

Processing resource 128 can be a central processing unit (CPU), a semiconductor-based processing resource, and/or other hardware devices suitable for retrieval and execution of machine-readable instructions such as instructions 132, 134, 136, 138, 140 stored in a memory resource 130. Processing resource 128 can fetch, decode, and execute instructions such as instructions 132, 134, 136, 138, 140. As an alternative or in addition to retrieving and executing instructions 132, 134, 136, 138, 140, processing resource 128 can include a plurality of electronic circuits that include electronic components for performing the functionality of instructions 132, 134, 136, 138, 140.

Memory resource 130 can be any electronic, magnetic, optical, or other physical storage device that stores executable instructions 132, 134, 136, 138, 140 and/or data. Thus, memory resource 130 can be, for example, Random Access Memory (RAM), an Electrically-Erasable Programmable Read-Only Memory (EEPROM), a storage drive, an optical disc, and the like. Memory resource 130 can be disposed within the HMD 100, as shown in FIG. 1. Additionally and/or alternatively, memory resource 130 can be a portable, external or remote storage medium, for example, that causes the processing resource 128 to download the instructions 132, 134, 136, 138, 140 from the portable/external/remote storage medium.

The memory resource 130 can include instructions 132 that are executable by the processing resource 128 to designate a first field of view (e.g., of the first sensor 102-F of an HMD 100) as an active area. As used herein, “designation of an active area” refers to a designation of a field of view of a sensor for detection of pose, hand controller, and/or position, but not gesture detection. For instance, a designated active area can exclusively detect hand controller, position, and/or pose in the active area, rather than gestures. For example, the first sensor 102-F can be a sensor such as a camera with a field of view of which some or all is designated as an active area. As used herein, a “camera” refers to an optical instrument to capture still images and/or to record moving images. For example, a camera can be utilized to capture and/or record position, pose, hand controller, and/or gestures, depending, for instance, on designation of a field of view of the camera as an active area or a gesture area. For instance, the memory resource 130 can include instructions 134 that are executable by the processing resource 128 to detect, via the first sensor 102-F when present, pose and controller movement in the active area.

The memory resource 130 can include instructions 136 that are executable by the processing resource 128 to designate a second field of view (e.g., of the second sensor 104-S of a HMD 100) as a gesture area. For instance, a designated gesture area can exclusively detect gestures in the area (rather than hand controller movement, position, and/or pose, etc.). For example, the second sensor 104-S can be a sensor such as a camera with a field of view of which some or all is designated as a gesture area. The memory resource 130 can include instructions 138 that are executable by the processing resource 128 to detect, when present, a gesture in the gesture area.

The memory resource 130 can include instructions 140 that are executable by the processing resource 128 to cause an effect of the gesture to occur responsive to detection of the gesture. As used herein, an “effect” of a gesture refers to a predetermined outcome responsive to detection of the gesture. Examples of effects include moving/selecting objects displayed in the HMD, selecting from menus displayed in the HMD, adjusting parameters, generating text, among other possible effects that occur responsive to detection of a gesture.

FIG. 2 is a top view of the example of the HMD of FIG. 1. The HMD 200 can include a plurality of outward facing sensors such as front-facing sensors and side-facing sensors. As used herein and detailed with respect to FIG. 3, a “front-facing” sensor refers to a sensor having an orientation that is substantially similar to a natural/virtual field of view of a user when wearing the HMD. For instance, the HMD can include front-facing sensors 202-1, . . . , 202-F. As used herein, “side-facing sensors have a field of view at an orientation that is substantially different than a natural/virtual field of view of the user wearing the HMD, for instance, such that the field of view of a side-facing sensor can be orthogonal to the field of view of that user. For instance, the HMD 200 can include a plurality of side-facing sensors 204-1, . . . , 204-S.

As illustrated in FIG. 2, the fields of view 203-1, . . . , 203-W of the front-facing sensors 202-1, . . . , 202-F, respectively, can be designated as an active area. Thus, the front-facing sensors 202-1, . . . , 202-F can detect pose, position, and/or hand controller movement in the fields of view 203-1, . . . , 203-W (i.e., the active area). The active area can be located primarily/entirely in front of a user, as detailed herein with respect to FIG. 3, when wearing the HMD 200, for instance, to permit ease of detection of pose, position, and/or hand controller movement in the active area.

The fields of view 205-1, . . . , 205-G of the side-facing sensor 204-1, . . . , 204-S, respectively, can together be designated as a gesture area. Thus, the side-facing sensors 204-1, . . . , 204-S, can detect gestures in the fields of view 205-1, . . . , 205-G. That is, the gesture area can be located primarily/entirely to the side of a user, as detailed herein with respect to FIG. 3, when wearing the HMD 200, for instance, to permit ease of detection gestures in the gesture area.

Examples of gestures include a finger gesture, an arm gesture, a gesture with an object such as a controller gesture or hand gesture, or combinations thereof. A “controller gesture” refers to an orientation of a hand controller and/or a movement of the hand controller (resulting from movement of a hand holding or otherwise coupled to (e.g., strapped to) the hand controller). Examples of hand controllers include joysticks, wands, touchpads/touchscreens, among other types of hand controllers that can operate in conjunction with an XR device such as the HMD 200. A “finger gesture”, a “hand gesture”, an “arm gesture”, or combinations thereof refer to gestures performed by a hand not holding or otherwise coupled to a hand controller.

In some examples, a finger gesture, a hand gesture, an arm gesture, a controller gesture, or combinations thereof can be detected in the gesture area. Detection of such gestures in the gesture area (but not detection of position or pose in the gesture area) can reduce latency of and/or decrease computational bandwidth associated with gesture detection. In some examples, a finger gesture, a hand gesture, an arm gesture, or combinations thereof can be detected in the gesture area. Detection of such gestures in the gesture area (but not detection of position, pose, or controller gestures in the gesture area) can further reduce latency and/or further decrease overall computational bandwidth associated with gesture detection.

In some examples, the front-facing sensors 202-1, . . . , 202-F do not detect gestures performed in the fields of view 203-1, . . . , 203-W and/or ignore the gesture, when present; in the fields of view 203-1, . . . , 203-W. For instance; as detailed herein, the HMD 200 can include or receive instructions to not detect gestures performed in the fields of view in the fields of view 203-1, . . . , 203-W and/or ignore the gesture; when present, in the in the fields of view 203-1, . . . , 203-W. As used herein; “not detect gestures” refers to an absence of instructions to detect gestures and/or indicators (e.g., finger/hand orientation/movement) of potential gestures. As used herein, to “ignore a gesture”/“ignore gestures” refers to an absence of a causing an effect responsive to detection of a gesture. For instance, a gesture (e.g., a pinching movement performed by fingers of a user) can be detected by a sensor (e.g., the first sensor 102-F) but ignored such that the effect associated with the gesture (e.g., resizing a virtual object) does not occur. That is; in some examples, gestures performed in the fields of view 203-1, . . . , 203-W can be ignored or are not detected.

Rather, in some examples, gestures are exclusively detected in a gesture area. Detection of gestures exclusively in the gesture area (and/or ignoring gestures present in the active area) can mitigate/eliminate detection of gestures inadvertently performed in the active area, increase a total number of permissible due to increased granularity when detecting gestures; and/or reduce a total amount of computational bandwidth associated with gesture detection.

In some examples, the fields of view 203-1, . . . , 203-W of the front-facing sensors 202-1, . . . , 202-F can overlap with a distill portion (relative to a center of a user natural/virtual field of view) of the fields of view of 205-1, . . . , 205-G of the side-facing sensor 204-1, . . . , 204-S to form a common area 207, as illustrated in FIG. 2. As used herein, a “common area” refers to a portion of a field of view of a sensor (e.g., a front-facing sensor) that is shared with (i.e., overlaps) a field of view of another sensor (e.g., a side-facing sensor). In such examples, the active area can be designated as the area of the fields of view 203-1, . . . , 203-W that is not overlapped by the area of the fields of view 205-1, . . . , 205-G, while the gesture area can be designated as the area of the fields of view 205-1, . . . , 205-G that is not overlapped by the area of the fields of view 203-1, . . . , 203-W.

In some examples, the HMD 200 cannot detect or is to ignore a gesture performed in the common area 207. For example, a pinch gesture performed (but not detected) in the common area 207 can have no effect. Similarly, a pinch gesture detected in the common area 207, can be ignored such that the pinch gesture has no effect. Conversely, the same pinch gesture performed in the gesture area can cause virtual object displayed in the HMD 200 to be resized, among other possible effects.

However, in some examples the HMD 200 is to detect a gesture performed in the common area and cause an effect associated with the gesture to occur. Detection of a gesture in the common area 207 can result in the causation of an effect that is the same or different than an effect caused when the gesture is detected in the gesture area. For example, a gesture (e.g., a hand swipe) detected in a common area can cause an effect (e.g., a virtual window/menu closing) that different than an effect (close an currently running application) caused when the same gesture is detected in the gesture area, Stated differently, in some examples, a gesture can cause a first effect when the gesture is detected in the common area and cause a second effect (different than the first effect) when the gesture is detected in the gesture area. Having a gesture provide different effects depending on where the gesture is detected can lead to less inadvertent gestures (e.g., due to ignoring/not detecting gestures in the active area) and/or provide a greater total number of possible effects (e.g., due to have multiple location dependent effects associated with a gesture such as different effects of a gesture performed in the common area or the gesture area).

In some examples, a boundary can be represented between the common area (e.g., the common area 207), the active area, and/or the gesture area. For instance, a boundary (e.g., a boundary 209) between an active area and a gesture area could be represented visually by a dashed-line, by different color/gradient/shading on opposing sides of the boundary (e.g., a first color for the active area and a second different color for the gesture area), among other possible visual representations of the common area, the boundary, and/or the work/gesture area.

In some examples, the HMD 200 can provide feedback to a user wearing the HMD 200 depending on a position of an object such as a hand of the user relative to the gesture area, the active area, the common area, and/or a boundary therebetween. For instance, audio or haptic feedback could be provided via a speaker and/or haptic feedback device included in the HMD 200. For example, a haptic feedback device included in the HMD 200 can provide haptic feedback to a user to indicate a boundary has been crossed by an object such as a hand.

FIG. 3 is another top view of the example of a HMD of FIG. 1. The HMD 300 can include a head strap 301 to attach the HMD 300 to a head 310 of a user 308, A user 308 wearing the HMD 300 can have a field of view (as represented by 311). The field of view 311 can be a natural field of view of the user's eyes (e.g., in the case of AR) or can be a virtual field of view (e.g., in the case of VR). Regardless, the field of view 311 can extend a distance in a direction that is located in front (in front of a face) of the user 308. While various fields of view are illustrated in the Figures and at times described herein in two-dimensions it is understood that a field of view refers to a three-dimensional area such as a three-dimensional cone shaped area or other three-dimensional shaped area.

The HMD 300 can include a plurality of front-facing sensors 302-1, . . . , 302-F, and a plurality of side-facing sensors 304-1, . . . , 304-S. The front-facing sensors 302-1, . . . , 302-F can be positioned on the HMD 300 so the front-facing sensors 302-1, . . . , 302-F have a field of view that is substantially similar to the field of view 311 of the user 308, As used herein, the term “substantially” intends that the characteristic does not have to be absolute, but is close enough so as to achieve the characteristic. For example, being “substantially similar to a field of view of a user” is not limited to absolute the same as the field of view of a user. For instance, each a field of view 303-1, . . . , 303-W of the front-facing sensors 302-1, . . . , 302-F, respectively, can be within 0.5°, 1°, 2°, 5°, 10°, 20° 45°, 60° etc. of the field of view 311. As a result, an entire field of view of each of the fields of view 303-1, . . . , 303-W of the front-facing sensors 302-1, . . . , 302-F can be encompassed by the field of view 311, in some examples. However, in some examples a majority, but not all of, fields of view 303-1, . . . , 303-W of the front-facing sensors 302-1, . . . , 302-F can be encompassed by the field of view 311.

The side-facing sensors 304-1, . . . , 304-S can be positioned on the HMD 300 so the side-facing sensors 304-1, . . . , 304-S have a field of view 305-1, . . . , 305-G that is substantially different than the field of view 311 of the user 308. Being “substantially different” than the field of view of a user is not limited to an absolute different field of view than the field of view 311. For instance, each field of view of the fields of view 305-1, . . . , 305-G of the side-facing sensors 304-1, . . . , 304-S can be entirely outside of the field of view 311 or can overlap 0.5°, 1°, 2°, 5°, 10°, 20° or 45°, etc. of a distal portion (relative to a center of the field of view extending from between the eyes of the user) of the field of view 311. For instance, in some examples, a majority, but not all of, the fields of view 305-1, . . . , 305-G of the side-facing sensors 304-1, . . . , 304-S can be outside of the field of view 311.

In some examples, an entire field of view of each field of view of the fields of view 305-1, . . . , 305-G of the side-facing sensors 304-1, . . . , 304-S can be entirely outside of the field of view 311, as illustrated in FIG. 2. However, as illustrated in FIG. 2 in some instances, a portion of the fields of (e.g., 203-1, . . . , 203-W) of the front-facing sensors (e.g., 202-1, . . . , 202-F) can overlap with the fields of view (e.g., 205-1, . . . , 205-G) of the side-facing sensors (e.g., 204-1, . . . , 204-S).

A “controller gesture” can be performed by the hand 312-H holding a controller 314 and can be detected in the active area (e.g., in fields of view 303-1, . . . , 303-W). A “finger gesture”, a “hand gesture”, an “arm gesture”, or combinations thereof refer to gestures performed by a hand 312-1 not holding or otherwise coupled to the hand controller 314. While illustrated as an individual hand 312-1, it is understood that the “finger gesture”, a “hand gesture”, an “arm gesture”, or combinations thereof can employ an individual hand or can employ two hands of a user such as user 308.

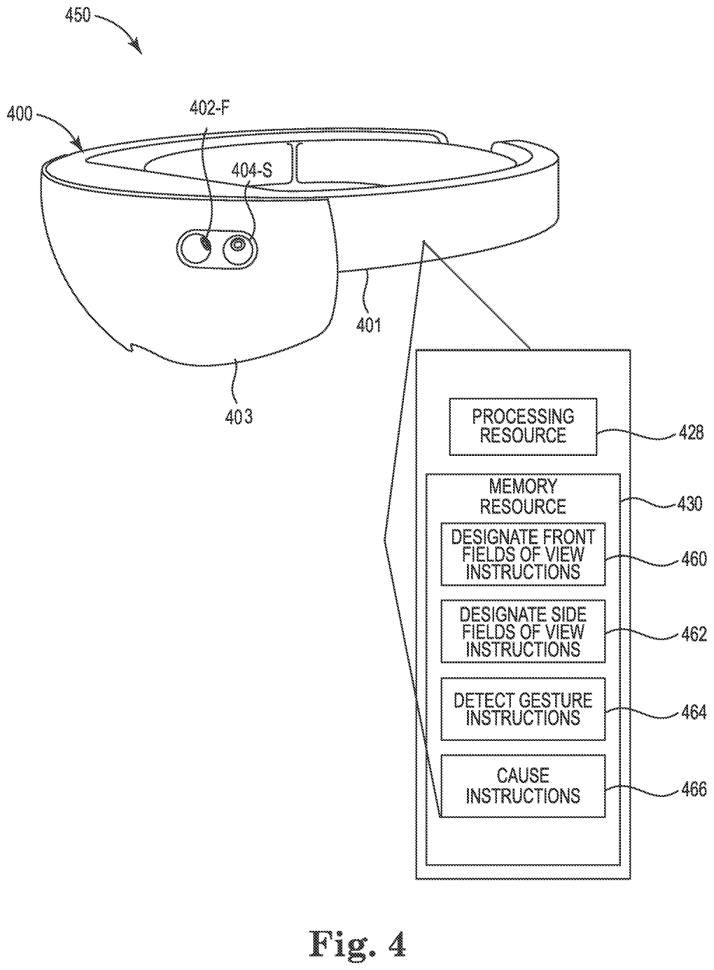

FIG. 4 is a side-view of an example of system 450 including a HMD 400 having a gesture area. As described herein, the HMD 400 can include a head strap 401, a display 403, a first sensor 402-F, and a second sensor 404-S.

As illustrated in FIG. 4, the HMD 400 can be coupled to, but not include, a processing resource 428 and/or a memory resource 430. For instance, the HMD 400 can be coupled in a wired or wireless manner to the processing resource 428 and/or the memory resource 430.

The memory resource 430 can include instructions 460 that are executable by a processing resource 428 to designate fields of view of the plurality of front-facing sensors as an active area, as described herein. The instructions can designate some or all of the fields of view as an active area. In various examples, an entire field of view of each field of view of the front-facing sensors is designated as an active area. For instance, an entirety of a first field of view of a first front-facing sensor and an entirety of a second field of view of a second front-facing sensor can each be designated as an active area. However, in some examples, a portion of a field of view of a front-facing sensor that overlaps with a field of view of a side-facing sensor can be designated as a common area.

The memory resource 430 can include instructions 462 that are executable by the processing resource 428 to designate the fields of view of the plurality of side-facing sensors as a gesture area, as described herein. In various examples, an entire field of view of each field of view of the side-facing sensors is designated as a gesture area. For instance, an entirety of a first field of view of a first side-facing sensor and an entirety of a second field of view of a second side-facing sensor can each be designated as a gesture area. However, in some example a portion of a field of view of a side-facing sensor that overlaps with a field of view of a front-facing sensor can be designated as a common area.

The memory resource 430 can include instructions 464 that are executable by the processing resource 428 to detect, when present in the gesture area, a gesture. For instance, a side-facing sensor can detect a particular orientation and/or motion of a hand/arm of a user wearing the HMD 400 as corresponding to a gesture (e.g., a swipe gesture) stored in the memory resource 430 or otherwise stored.

The memory resource 430 can include instructions 466 that are executable by the processing resource 428 to cause an effect of the gesture to occur responsive to detection of the gesture. For instance, the detected gesture (e.g., the swipe gesture) can cause an effect (a virtual window/menu closing) when detected in a gesture area and/or in a common area, as detailed herein.

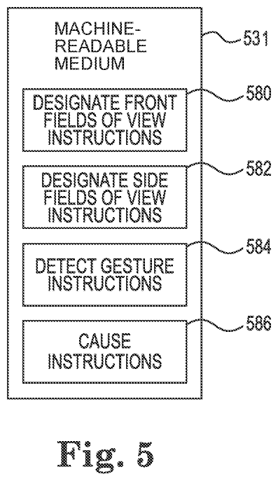

FIG. 5 is an example of a machine-readable medium 531 storing instructions executable by a processing resource such as those described herein to provide a gesture area. In various examples, the machine-readable medium 531 can include machine-readable instructions 580 executable by a processing resource to designate a first field of view of a first sensor of a HMD as an active area, as described herein.

The machine-readable medium 531 can include machine-readable instructions 582 executable by a processing resource to designate a second field of view of a second sensor of the HMD as a gesture area, as described herein.

The machine-readable medium 531 can include machine-readable instructions 584 executable by a processing resource to detect, when present, a gesture in the gesture area. For instance, in some examples the machine-readable medium 531 can include instructions to detect an object gesture such as a finger gesture, a hand gesture, an arm gesture, a controller gesture, or combinations thereof, as described herein. However, in some examples the machine-readable medium 531 can include instructions to detect a finger gesture, a hand gesture, an arm gesture, or combinations thereof, as described herein, but not a controller gesture.

In some examples, a portion of the first field of view and a portion of the second field of view can overlap to form a common area, as discussed herein. In such examples, the machine-readable medium 531 can include instructions to detect, when present, a gesture in the common area and/or a gesture area, as described herein.

In some examples, the machine-readable medium 531 can include instructions to exclusively detect the gesture in the gesture area and detect gestures in a common area, if present. In such examples, the machine-readable medium 531 does not detect and/or ignores any gestures performed in the active area. However, in some examples, the machine-readable medium 531 can include instructions to exclusively detect the gesture in the gesture area. In such examples, the machine-readable medium 531 includes instructions that do not detect and/or ignores any gestures performed in the active area and any gestures performed in common area, if a common area is present.

The machine-readable medium 531 can include machine-readable instructions 586 executable by a processing resource to cause an effect of the gesture to occur responsive to detection of the gesture. For instance, the effect can be a corresponding action (e.g., minimize workspace) in an application (e.g., a video game or productivity software) or execution of corresponding user interface command (e.g., menu open), among other possible types of effects. In some examples the machine-readable medium 531 can include instructions to cause a first effect when the gesture is detected in the common area and cause a second effect (e.g., different than a first effect) when the gesture is detected in the gesture area, as described herein.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure. Further, as used herein, “a” can refer to one such thing or more than one such thing. It can be understood that when an element is referred to as being “on,” “connected to”, “coupled to”, or “coupled with” another element, it can be directly on, connected, or coupled with the other element or intervening elements can be present.

The figures herein follow a numbering convention in which the first digit corresponds to the drawing figure number and the remaining digits identify an element or component in the drawing. For example, reference numeral 102 can refer to element 100 in FIG. 1 and an analogous element can be identified by reference numeral 200 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

What is claimed is:

1. A machine-readable medium storing instructions executable by a processing resource to:
designate a first field of view of a first sensor of a head-mounted display as an active area;
designate a second field of view of a second sensor of the head-mounted display as a gesture area;
detect, when present, a gesture in the gesture area; and
cause an effect of the gesture to occur responsive to detection of the gesture.

2. The medium of claim 1, including instructions to exclusively detect the gesture in the gesture area.

3. The medium of claim 1, including instructions to ignore the gesture, when present, in the active area.

4. The medium of claim 1, including instructions to detect an object gesture in the gesture area, wherein the object gesture is a finger gesture, a hand gesture, an arm gesture, a controller gesture, or combinations thereof.

5. The medium of claim 1, including instructions to detect a finger gesture, a hand gesture, an arm gesture, or combinations thereof in the gesture area.

6. The medium of claim 1, wherein a portion of the first field of view and a portion of the second field of view overlap to form a common area.

7. The medium of claim 6, including instructions to detect, when present, a gesture in the common area.

8. The medium of claim 7, including instructions to:
cause a first effect when the gesture is detected in the common area; and
cause a second effect when the gesture is detected in the gesture area.

9. The medium of claim 1, including instructions to designate the entire field of view of the second sensor of the head-mounted display as the gesture area.

10. A head-mounted display comprising:
outward facing sensors including a first sensor having a first field of view and a second sensor having a second field;
a processing resource; and
a memory resource storing non-transitory machine-readable instructions that are executable by the memory resource to:
designate the first field of view as an active area;
detect, when present, pose and controller movement in the active area;
designate the second field of view as a gesture area;
detect, when present, a gesture in the gesture area; and
cause an effect of the gesture to occur responsive to detection of the gesture.

11. The head-mounted display of claim 10, wherein the first sensor is a front-facing sensor and wherein the second sensor is a side-facing sensor.

12. The head-mounted display of claim 10, wherein the first sensor and the second sensor are cameras.

13. The head-mounted display of claim 12, wherein the instructions further comprise instructions to process images from the first sensor at a higher frame rate than images from the second sensor.

14. A system comprising:
a head-mounted display including a plurality of outward facing sensors each having a respective field of view, wherein the plurality of outward facing sensors include a plurality of front-facing sensors and a plurality of side-facing sensors;
a processing-resource; and
a memory resource storing non-transitory machine-readable instructions that are executable by the memory resource to:
designate the fields of view of the plurality of front-facing sensors as an active area;
designate the fields of view of the plurality of side-facing sensors as a gesture area;
detect, when present in the gesture area, a gesture; and
cause an effect of the gesture to occur responsive to detection of the gesture.

15. The system of claim 14, wherein the memory resource further comprises instructions to provide haptic or visual feedback, via an output mechanism of the head-mounted display, when an object crosses a boundary between the active area and the gesture area.
